(19) United States
(12) Patent Application Publication
(10) Pub. No.: US 2021/0262076 A1
(43) Pub. Date: Aug. 26, 2021

(54) GRAPHENE COPPER PANTOGRAPH PAN MATERIAL FOR HIGH-SPEED TRAINS AND PREPARATION METHOD THEREOF

(71) Applicant: NORTHEASTERN UNIVERSITY, Shenyang, Liaoning (CN)

(72) Inventors: Lianwei YANG, Shenyang, Liaoning (CN); Ruijie WANG, Shenyang, Liaoning (CN)

(21) Appl. No.: 17/055,920

(22) PCT Filed: Jun. 24, 2019
(86) PCT No.: PCT/CN2019/092489

§ 371 Date: Nov. 16, 2020

(51) Int. Cl. C22C 47/14; B22F 3/15; B22F 5/00; B22F 1/00; B60L 5/20; C22C 49/02; C22C 49/14

(52) U.S. Cl. CPC C22C 47/14; B22F 3/15; B22F 5/00; C22C 49/14; B60L 5/20; C22C 49/02; B22F 1/0025

(57) ABSTRACT

The present invention provides a graphene copper pantograph pan material for high-speed trains and a preparation method thereof, and the pan uses graphene as a reinforcing material, copper and iron as base materials, coke powder and graphite fiber as self-lubricating wear-resistant materials, and titanium, tungsten and molybdenum as additives. After being uniformly mixed, all the components are directly formed by hot pressing. The pantograph pan prepared by the present invention has the advantages of favorable electrical conductivity, wear resistance, impact resistance, ablation resistance and the like, and has little wear to overhead lines. The pan not only has simple preparation process, but also has much better performance than the conventional carbon pans and metal impregnated pans. The pan material is not only suitable for pantograph pans for high-speed trains such as high-speed rails and bullet trains, but also suitable for electric contact materials for low-speed trains such as subways.

### TECHNICAL FIELD

The present invention belongs to the field of new materials, and relates to a preparation method of a high-performance graphene copper pantograph pan material, which can be used for high-speed trains such as high-speed rails and bullet trains and also can be used for low-speed trains such as urban subways.

### BACKGROUND

The pantograph pan is called pan for short, and is an important current collection element on trains such as high-speed rails and bullet trains. The pan is installed on a pantograph and is in direct contact with overhead lines. The current through the transmission grid is guided down by the contact between the pantograph pan and the transmission grid line and transmitted to the power supply system of a locomotive to maintain the normal operation of the electric locomotive. Therefore, the pan is required to have favorable electrical conductivity, wear resistance and impact toughness and have wear as low as possible to overhead lines. With the rapid development of high-speed rails, the improvement of the pan performance becomes one of focal points for research and development at home and abroad.

The pans commonly used at present have three main types: carbon pan, powder metallurgy pan and metal impregnated carbon pan. The carbon pan has good wear resistance, but has high electrical resistivity and poor impact resistance, and is prone to breakage. The powder metallurgy pan has good electrical conductivity and impact toughness, but has serious wear to overhead lines, causing the network outage fault of overhead lines. The metal impregnated carbon pan has higher electrical conductivity and impact toughness than the carbon pan, but has serious wear to overhead lines, and is prone to breakage during operation. In order to solve the deficiencies of the pantograph pan in use, various improved pantograph pans such as aluminum-coated carbon pan, carbon fiber reinforced carbon pan and graphite reinforced aluminum pan are developed successively, which have improved performance but still have various problems.

For example, the patent for invention with the publication number of CN108422868A discloses a carbon-carbon composite pantograph pan for electric locomotives, and the pan uses carbon fiber cloth, phenolic resin, nitrile rubber and graphite powder as the continuous phase and uses chopped carbon fibers and copper fibers as the reinforcement phase to prepare the carbon fiber composite. The preparation process is complex, and the electrical resistivity of the pan is high.

The patent with the publication number of CN108503363A discloses a carbon-carbon composite pantograph pan and a preparation method thereof, and the pan is prepared from raw materials of carbon, pitch coke, semi-reinforcing purpose furnace black, graphite and adhesives by extrusion molding, green roasting and other complex processes, has good wear resistance, but has poor strength and high electrical resistivity.

The patent for invention with the publication number of CN105272254A discloses a preparation method of a pantograph pan material, the pan is prepared from raw materials of electrolytic graphene, semi-reinforcing purpose furnace black and needle petroleum coke, and the preparation method thereof comprises kneading, forming, primary roasting, impregnation, secondary roasting and other processes. The pan has good impact resistance but has complicated preparation process and poor comprehensive performance.

### SUMMARY

In view of the defects in the prior art, the purpose of the present invention is to propose a preparation method of a high-performance pantograph pan material, and the pan material uses graphene as a reinforcing material, copper and iron as base materials, coke powder and graphite fiber as self-lubricating wear-resistant materials, and titanium, tungsten and molybdenum as additives. After being uniformly mixed, all the components are directly formed by hot pressing. The present invention has the following specific technical solution:

A graphene copper pantograph pan material for high-speed trains comprises the following components by mass ratio: 2.0-11.0 wt % of graphene, 30.5-60.5 wt % of copper powder, 1.0-19.0 wt % of iron powder, 8.0-37.0 wt % of coke, 1.0-5.0 wt % of carbon nanotube, 0.4-6.2 wt % of graphite fiber and 0.06-0.25 wt % of additive.

The additive is formed by mixing titanium powder of 600-800 meshes, tungsten powder of 800-1200 meshes and molybdenum powder of 900-1200 meshes, and the mass ration of titanium powder to tungsten powder to molybdenum powder is 1:3:5.

Further, the particle size of the copper powder used is 400-600 meshes, and the particle size of the iron powder is 900-1200 meshes.

Further, the carbon nanotube used is single-wall or multi-wall, with the diameter of 2-10 nm and the length of 0.5-8 μm.

Further, the particle size of the coke used is 100-400 meshes, and the graphite fiber is high-strength fiber, with the diameter of 4-8 μm and the length of 0.5-3 cm.

The method for preparing the graphene copper pantograph pan material for high-speed trains comprises the following steps:

(1) First, uniformly dispersing graphene, additive and carbon nanotube in a polyvinyl alcohol solution with the concentration of 8.5% according to the mass ratio of the components of the material, wherein the mass ratio of graphene to polyvinyl alcohol is 1:10, then adding copper powder, iron powder, coke and graphite fiber to the mixed solution in sequence, and stirring uniformly;

(2) Drying the mixed solution prepared in step (1) in vacuum, wherein the drying temperature is 30° C.-50° C.;

(3) Taking out the dried material and placing in the sample hot-pressing groove of a hot press for direct vacuum hot pressing, wherein the pressure intensity for hot pressing is 40-120 MPa, the temperature is 850° C.-1200° C., and the holding time is 8-20 min, thus obtaining a graphene copper pantograph pan material.

The present invention has the following beneficial effects: the pan has friction and wear resistance, high electrical conductivity, strong impact resistance, self-lubrication performance and low wear to overhead lines. The pan not only has simple preparation process, but also has much better performance than the conventional carbon pans and metal impregnated pans. The pan material is not only suitable for pantograph pans for high-speed trains such as high-speed rails and bullet trains, but also suitable for electric contact materials for low-speed trains such as subways.

### DETAILED DESCRIPTION

### Embodiment 1

(1) First, uniformly dispersing 2 wt % of graphene, 0.20 wt % of additive and 3 wt % of carbon nanotube (with the diameter of about 3 nm and the length of about 0.5 μm) in a polyvinyl alcohol solution, then adding 57 wt % of copper powder of 400 meshes, 17 wt % of iron powder of 900 meshes, 20.8 wt % of coke of 400 meshes and 6 wt % of graphite fiber (with the diameter of about 4 μm and the length of about 2 cm) to the solution in sequence, and stirring uniformly.

(2) Drying the mixture in vacuum, wherein the drying temperature is 30° C.

(3) Taking out the dried material and placing in the sample hot-pressing groove of a hot press for direct vacuum hot pressing, wherein the pressure intensity for hot pressing is 50 MPa, the hot pressing temperature is 1100° C., and the holding time is 12 min.

The prepared pan has the density of 4.27 g/cm³, the electrical resistivity of 0.12 μΩ·m, the impact toughness of 5.90 J/cm², the bending strength of 381 MPa, the friction coefficient of 0.052, and the compressive strength of 370 MPa.

### Embodiment 2

(1) First, uniformly dispersing 5 wt % of graphene, 0.10 wt % of additive and 5 wt % of carbon nanotube (with the diameter of about 4 nm and the length of about 1 μm) in a polyvinyl alcohol solution, then adding 53 wt % of copper powder of 500 meshes, 15 wt % of iron powder of 1100 meshes, 19.9 wt % of coke of 200 meshes and 2 wt % of graphite fiber (with the diameter of about 5 μm and the length of about 3 cm) to the solution in sequence, and stirring uniformly.

(2) Drying the mixture in vacuum, wherein the drying temperature is 30° C.

(3) Taking out the dried material and placing in the sample hot-pressing groove of a hot press for direct vacuum hot pressing, wherein the pressure intensity for hot pressing is 80 MPa, the hot pressing temperature is 1000° C., and the holding time is 9 min.

The prepared pan has the density of 4.21 g/cm³, the electrical resistivity of 0.14 μΩ·m, the impact toughness of 5.72 J/cm², the bending strength of 370 MPa, the friction coefficient of 0.045, and the compressive strength of 360 MPa.

### Embodiment 3

(1) First, uniformly dispersing 8 wt % of graphene, 0.08 wt % of additive and 4 wt % of carbon nanotube (with the diameter of about 5 nm and the length of about 2 μm) in a polyvinyl alcohol solution, then adding 50 wt % of copper powder of 600 meshes, 12 wt % of iron powder of 1200 meshes, 23 wt % of coke of 300 meshes and 2.92 wt % of graphite fiber (with the diameter of about 6 μm and the length of about 1 cm) to the solution in sequence, and stirring uniformly.

(2) Drying the mixture in vacuum, wherein the drying temperature is 30° C.

(3) Taking out the dried material and placing in the sample hot-pressing groove of a hot press for direct vacuum hot pressing, wherein the pressure intensity for hot pressing is 100 MPa, the hot pressing temperature is 1100° C., and the holding time is 8 min.

The prepared pan has the density of 4.17 g/cm³, the electrical resistivity of 0.16 μΩ·m, the impact toughness of 5.50 J/cm², the bending strength of 361 MPa, the friction coefficient of 0.040, and the compressive strength of 349 MPa.

### Embodiment 4

(1) First, uniformly dispersing 10 wt % of graphene, 0.12 wt % of additive and 2 wt % of carbon nanotube (with the diameter of about 8 nm and the length of about 6 μm), in a polyvinyl alcohol solution, then adding 48 wt % of copper powder of 600 meshes, 10 wt % of iron powder of 1000 meshes, 28 wt % of coke of 100 meshes and 1.88 wt % of graphite fiber (with the diameter of 8 about μm and the length of about 0.5 cm) to the solution in sequence, and stirring uniformly.

(2) Drying the mixture in vacuum, wherein the drying temperature is 30° C.

(3) Taking out the dried material and placing in the sample hot-pressing groove of a hot press for direct vacuum hot pressing, wherein the pressure intensity for hot pressing is 120 MPa, the hot pressing temperature is 900° C., and the holding time is 11 min.

The prepared pan has the density of 4.11 g/cm³, the electrical resistivity of 0.18 μΩ·m, the impact toughness of 5.35 J/cm2, the bending strength of 347 MPa, the friction coefficient of 0.032, and the compressive strength of 337 MPa.

1. A method for preparing a graphene copper pantograph pan material for high-speed trains, wherein the method comprises the following steps:
(1) first, uniformly dispersing graphene, additive and carbon nanotube in a polyvinyl alcohol solution with the concentration of 8.5% according to the mass ratio of the components of the graphene copper pantograph pan material, wherein the mass ratio of graphene to polyvinyl alcohol is 1:10, then adding copper powder, iron powder, coke and graphite fiber to the mixed solution in sequence, and stirring uniformly;
the graphene copper pantograph pan material comprises the following components by mass ratio: wherein 2.0-11.0 wt % of graphene, 30.5-60.5 wt % of copper powder, 1.0-19.0 wt % of iron powder, 8.0-37.0 wt % of coke, 1.0-5.0 wt % of carbon nanotube, 0.4-6.2 wt % of graphite fiber and 0.06-0.25 wt % of additive; the additive is formed by mixing titanium powder of 600-800 meshes, tungsten powder of 800-1200 meshes and molybdenum powder of 900-1200 meshes, and the mass ration of titanium powder to tungsten powder to molybdenum powder is 1:3:5;
(2) drying the mixed solution prepared in step (1) in vacuum, wherein the drying temperature is 30° C.-50° C.;
(3) taking out the dried material and placing in the sample hot-pressing groove of a hot press for direct vacuum hot pressing, wherein the pressure intensity for hot pressing is 40-120 MPa, the temperature is 850° C.-1200° C., and the holding time is 8-20 min, thus obtaining a graphene copper pantograph pan material.

2. (canceled)

3. The method for preparing the graphene copper pantograph pan material for high-speed trains according to claim 1, wherein the particle size of the copper powder used is 400-600 meshes, and the particle size of the iron powder is 900-1200 meshes.

4. The method for preparing the graphene copper pantograph pan material for high-speed trains according to claim 1, wherein the carbon nanotube used is single-wall or multi-wall, with the diameter of 2-10 nm and the length of 0.5-8 μm.

5. The method for preparing the graphene copper pantograph pan material for high-speed trains according to claim 1, wherein the particle size of the coke used is 100-400 meshes, and the graphite fiber is high-strength fiber, with the diameter of 4-8 μm and the length of 0.5-3 cm.

6. (canceled)
